(19) United States
(12) Patent Application Publication
(10) Pub. No.: US 2005/0009474 A1
(43) Pub. Date: Jan. 13, 2005

(54) Dedicated short-range communications (DSRC) on-board unit with adhesive material

(75) Inventor: Masahiro Inoue, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/679,323

(22) Filed: Oct. 7, 2003

(30) Foreign Application Priority Data
Jul. 11, 2003 (JP) 2003-195803

(51) Int. Cl. H04M 1/00

(52) U.S. Cl. 455/90.3; 455/550.1; 455/575.1

(57) ABSTRACT

A Dedicated Short-Range Communications (DSRC) on-board unit with an adhesive material includes: an antenna and a radio portion for communicating with roadside radio equipment; a data processing portion for processing data received from the radio portion; a housing in which at least the antenna, the radio portion, and the data processing portion are housed; and a double-sided adhesive tape having a first surface affixed to the housing and a second surface for affixing to a vehicle window, an aperture being formed in the double-sided adhesive tape and a protruding portion inserted into the double-sided adhesive tape being disposed on the housing.

### BACKGROUND OF THE INVENTION

1. Field of the Invention

The present invention relates to a Dedicated Short-Range Communications (DSRC) on-board unit with an adhesive material provided with an adhesive material having a first surface affixed to a housing and a second surface for affixing to a vehicle window.

2. Description of the Related Art

Conventionally, Dedicated Short-Range Communications (DSRC) systems are systems that use waves in the microwave band to perform communications only in a limited zone on a road. DSRC systems provide benefit to drivers and to administrators of roads, parking lots, etc., by performing radio communications and performing various kinds of data transfer between roadside units disposed on roads and DSRC on-board units disposed in automotive vehicles to perform services such as collecting tolls, providing road reports, etc.

DSRC systems have been considered for various applications such as fee collection from Electronic Toll Collection (ETC) systems through to payment at service stations and drive-thrus, the provision of the traffic information, etc.

Conventionally, in known DSRC on-board units, an antenna bracket housing an antenna is constituted by an upper case and a lower case, an antenna apparatus being affixed to a windshield by double-sided adhesive tape on an upper surface of the upper case. (See Patent Japanese Patent Laid-Open No. 2003-8317 (Gazette), for example.)

In conventional DSRC on-board units, because double-sided adhesive tape is affixed around an outer peripheral portion of an upper case of an antenna bracket, one problem is that the adhesive surface area of the double-sided adhesive tape is large, increasing costs proportionately and making the application operation troublesome.

Other problems are that uniform force may not be applied to the whole of the double-sided adhesive tape during application, leaving air in the double-sided adhesive tape, and that portions of the double-sided adhesive tape may be turned up as a result of misalignment arising when the double-sided adhesive tape is applied to the upper surface of the upper case, both being aesthetically unacceptable.

### SUMMARY OF THE INVENTION

The present invention aims to solve the above problems and an object of the present invention is to provide a Dedicated Short-Range Communications (DSRC) on-board unit with an adhesive material enabling application surface area to be reduced, for which an operation of application to a vehicle window is facilitated, and which has a superior aesthetic appearance after application.

In order to achieve the above object, according to one aspect of the present invention, there is provided a Dedicated Short-Range Communications (DSRC) on-board unit with an adhesive material including: an antenna and a radio portion for communicating with roadside radio equipment; a data processing portion for processing data received from the radio portion; a housing in which at least the antenna, the radio portion, and the data processing portion are housed; and an adhesive material having a first surface affixed to the housing and a second surface for affixing to a vehicle window, wherein: a protruding portion engaged with the adhesive material is disposed on the housing.

### BRIEF DESCRIPTION OF THE DRAWINGS

FIG. 1 is an overall perspective of a Dedicated Short-Range Communications (DSRC) on-board unit with an adhesive material according to Embodiment 1 of the present invention;

FIG. 2 is a cross section of the DSRC on-board unit with an adhesive material in FIG. 1;

FIG. 3 is a plan of an interior portion of a housing in FIG. 2;

FIG. 4 is a diagram explaining a method for matching a resonance frequency;

FIG. 5 is a perspective of an antenna bracket of a DSRC on-board unit with an adhesive material according to Embodiment 2 of the present invention; and

FIG. 6 is an overall perspective of a DSRC on-board unit with an adhesive material representing another example of the present invention.

### DETAILED DESCRIPTION OF THE PREFERRED EMBODIMENTS

Preferred embodiments of the present invention will now be explained with reference to the drawings.

Embodiment 1

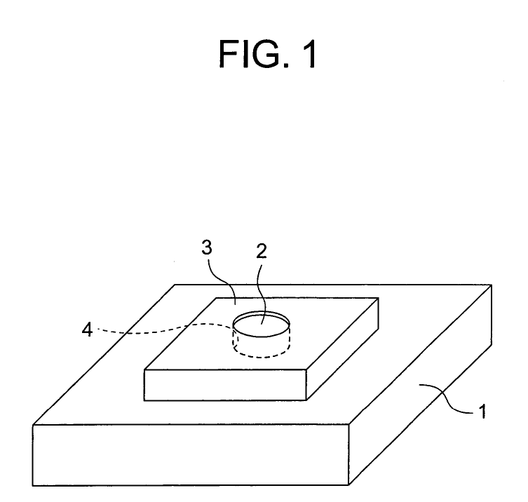

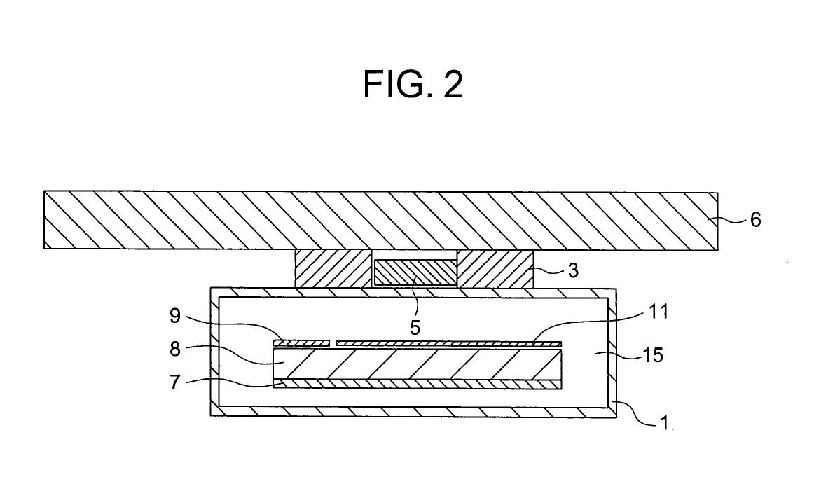

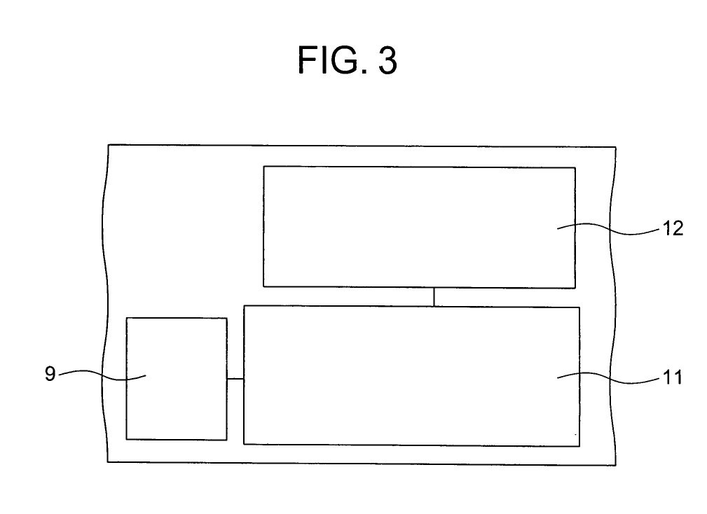

FIG. 1 is an overall perspective of a Dedicated Short-Range Communications (DSRC) on-board unit with an adhesive material according to Embodiment 1 of the present invention, FIG. 2 is a cross section of the DSRC on-board unit with an adhesive material in FIG. 1, and FIG. 3 is a plan of an interior portion of a housing in FIG. 2.

This Dedicated Short-Range Communications (DSRC) on-board unit with an adhesive material includes: a microstrip antenna 15 and a radio portion 11 for communicating with roadside radio equipment; a data processing portion 12 for processing data received from the radio portion 11; a housing 1 housing the microstrip antenna 15, the radio portion 11, and the data processing portion 12; and a double-sided adhesive tape 3 constituting an adhesive material having a first surface affixed to the housing 1 and a second surface for affixing to a windshield 6 constituting a vehicle window. The radio portion 11 converts modulated high-frequency waves into data enabling normal digital processing, and also converts digital signals into modulated high-frequency waves.

The microstrip antenna 15 includes: an antenna patch 9 for exciting radio waves to a desired frequency; an antenna ground (GND) 7 for returning the excitation current of the antenna patch 9; and an antenna dielectric 8 disposed between the antenna patch 9 and the antenna ground 7.

An aperture 4 is formed in the double-sided adhesive tape 3, and a cylindrical protruding portion 2 fitted into the aperture 4 is disposed on an upper surface of the housing 1. The height of this protruding portion 2 is less than the thickness of the double-sided adhesive tape 3. Furthermore, a leading end surface of the protruding portion 2 is a flat surface.

In this DSRC on-board unit with an adhesive material, since the double-sided adhesive tape 3 is shaped so as to surround the protruding portion 2, positioning of the double-sided adhesive tape 3 relative to the housing 1 is reliable, and after applying the double-sided adhesive tape 3 to the housing 1, this DSRC on-board unit with an adhesive material is affixed in a position that will not obstruct visibility through the windshield 6, such as behind a rear-view mirror, etc.

Because the height of the protruding portion 2 is less than the thickness of the double-sided adhesive tape 3, pressing depth for the double-sided adhesive tape 3 during application is ensured, enabling the double-sided adhesive tape 3 to be reliably pressed against the windshield 6.

The leading end surface of the protruding portion 2 is a flat surface, and by pushing this flat surface against the windshield 6, load is uniformly applied against the windshield 6 at the top, bottom, left and right of the housing 1, preventing adhesion irregularities, and as a result the occurrence of problems such as air bubbles, etc., is also reduced.

Because the housing 1 constituting a dielectric and the double-sided adhesive tape 3 are disposed on a front surface of the microstrip antenna 15, a misalignment may occur in the resonance frequency of the microstrip antenna 15, this phenomenon varying depending on the thickness of the dielectric and the distance from the antenna. Consequently, matching of antenna characteristics is carried out with the antenna 15 mounted inside the housing 1. This matching enables the housing 1 and the double-sided adhesive tape 3 to be disposed on the front surface of the antenna 15.

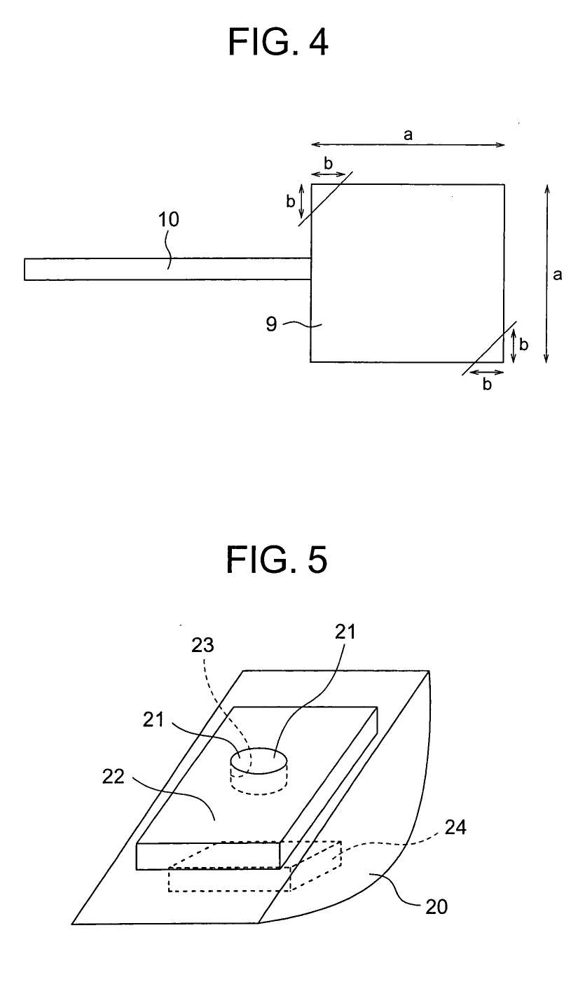

In the microstrip antenna 15 according to this embodiment, the resonance frequency is matched by adjusting lengths of dimensions a of the antenna patch 9 in FIG. 4. Specifically, the resonance frequency can be lowered by increasing the dimensions a, or the resonance frequency can be increased by reducing the dimensions a. Axial ratio characteristics, representing polarization characteristics of circular polarized waves used in the DSRC on-board unit, are adjusted by lengths of notch dimensions b of the antenna patch 9. Moreover, the numeral 10 in FIG. 4 indicates a feeder line connected to the antenna patch 9.

Antenna matching may also be carried out when the DSRC on-board unit is affixed to the windshield 6. Specifically, adaptation is performed by measuring the resonance frequency with the housing 1 affixed to the windshield 6, and adjusting the distance between the windshield 6 and the antenna 15, or varying the thickness of the double-sided adhesive tape 3, the magnitude of the housing 1, etc., in order to set the resonance frequency in that state to a desired frequency.

Embodiment 2

FIG. 5 is an overall perspective of a DSRC on-board unit with an adhesive material according to Embodiment 2 of the present invention. This DSRC on-board unit with an adhesive material includes: an antenna 24 for communicating with roadside radio equipment; an antenna bracket 20 constituting a housing for housing only the antenna 24; and a double-sided adhesive tape 22 constituting an adhesive material having a first surface affixed to the antenna bracket 20 and a second surface for affixing to a windshield 6 constituting a vehicle window. Furthermore, although not shown, this DSRC on-board unit with an adhesive material also includes an on-board unit main body in which a radio portion, a data processing portion, etc., are housed so as to be separated from the antenna bracket 20. This on-board unit main body may be mounted, for example, in a location separated from the antenna bracket 20 that is convenient for inserting and removing an integrated-circuit (IC) card, such as under a driver's seat, in a glove compartment, etc., and in some cases, may be mounted out of sight inside an automotive vehicle interior.

An aperture 23 is formed in the double-sided adhesive tape 22, and a cylindrical protruding portion 21 fitted into the aperture 23 is disposed on an upper surface of the antenna bracket 20. The height of this protruding portion 21 is the same as the thickness of the double-sided adhesive tape 22, and a leading end surface of the protruding portion 21 is a flat surface.

In this DSRC on-board unit with an adhesive material, since the double-sided adhesive tape 22 is shaped so as to surround the protruding portion 21, positioning of the double-sided adhesive tape 3 relative to the antenna bracket 20 is reliable, and after applying the double-sided adhesive tape 22 to the antenna bracket 20, this DSRC on-board unit with an adhesive material is affixed in a position that will not obstruct visibility through the windshield 6 such as behind a rear-view mirror, etc.

The protruding portion 21 and the double-sided adhesive tape 22 are disposed on a radiating surface of the antenna, and the shape of the antenna 24 does not need to be made much larger than the shape of the antenna bracket 20, enabling reductions in size and cost and making mounting possible in an automotive vehicle having little clearance between the windshield 6 and the rear-view mirror. A slim design for the mounting also becomes possible.

Because the height of the cylindrical protruding portion 21 fitted into the aperture 23 is the same as the thickness of the double-sided adhesive tape 22, misalignment of the double-sided adhesive tape 22 relative to the antenna bracket 20 can be eliminated, and if the protruding portion 21 and the double-sided adhesive tape 22 are made the same color, uniformity can be achieved between the double-sided adhesive tape 22 and the protruding portion 21 when applied, improving the aesthetic appearance.

Moreover, in the above embodiment, the height of the protruding portion 21 fitted into the aperture 23 of the double-sided adhesive tape 22 and the thickness of the double-sided adhesive tape 22 are the same, but the height of the protruding portion may also be less than the thickness of the double-sided adhesive tape in a similar manner to that of Embodiment 1.

Furthermore, a case in which a double-sided adhesive tape is used for the adhesive material has been explained, but of course the present invention is not limited to this construction, and a housing may also be affixed to a vehicle window by applying an adhesive to a surface of a tape facing the vehicle window.

In addition, in each of the above embodiments, a windshield 6 is explained as constituting the vehicle window, but the object to which the housing is affixed is not limited to a windshield.

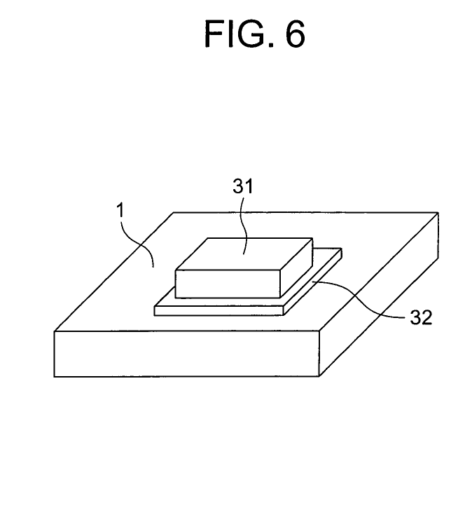

Still furthermore, in each of the above embodiments, a protruding portion 2 or 21 is disposed in an aperture 4 or 23 of a double-sided adhesive tape 3 or 22, but as shown in FIG. 6, a protruding portion 32 may also be disposed on a housing 1 so as to surround a double-sided adhesive tape 31.

As explained above, according to a Dedicated Short-Range Communications (DSRC) on-board unit according to the present invention, because a protruding portion engaged with an adhesive material is disposed on a housing, application surface area can be reduced, an operation of application to a vehicle window is facilitated, and aesthetic appearance after application is improved.

1. A Dedicated Short-Range Communications (DSRC) on-board unit with an adhesive material comprising:
an antenna and a radio portion for communicating with roadside radio equipment;
a data processing portion for processing data received from said radio portion;
a housing in which at least said antenna, said radio portion, and said data processing portion are housed; and
an adhesive material having a first surface affixed to said housing and a second surface for affixing to a vehicle window,
wherein:
a protruding portion engaged with said adhesive material is disposed on said housing.

2. A Dedicated Short-Range Communications (DSRC) on-board unit with an adhesive material comprising:
an antenna for communicating with roadside radio equipment;
a housing in which only said antenna is housed; and
an adhesive material having a first surface affixed to said housing and a second surface for affixing to a vehicle window,
wherein:
a protruding portion engaged with said adhesive material is disposed on said housing.

3. The Dedicated Short-Range Communications (DSRC) on-board unit with an adhesive material according to claim 1, wherein:
said protruding portion is fitted into an aperture formed on said adhesive material.

4. The Dedicated Short-Range Communications (DSRC) on-board unit with an adhesive material according to claim 1, wherein:
a height of said protruding portion is less than a thickness of said adhesive material.

5. The Dedicated Short-Range Communications (DSRC) on-board unit with an adhesive material according to claim 1, wherein:
a leading end surface of said protruding portion is a flat surface.

6. The Dedicated Short-Range Communications (DSRC) on-board unit with an adhesive material according to claim 1, wherein:
antenna characteristics are matched by adjusting a shape of said antenna.
